(19) United States
(12) Patent Application Publication
(10) Pub. No.: US 2013/0029296 A1
(43) Pub. Date: Jan. 31, 2013

(54) EDUCATIONAL METHODS, KITS AND SYSTEMS TO CREATE MEMORABILIA

(71) Applicants: Richard Petrovich, Marlton, NJ (US); Kathryn Petrovich, Marlton, NJ (US)

(72) Inventors: Richard Petrovich, Marlton, NJ (US); Kathryn Petrovich, Marlton, NJ (US)

(21) Appl. No.: 13/515,534

(22) PCT Filed: Dec. 14, 2010
(86) PCT No.: PCT/US10/60232

§ 371 Date: Jul. 1, 2012

Related U.S. Application Data
(60) Provisional application No. 61/286,494, filed on Dec. 15, 2009.

(51) Int. Cl. G09B 19/00

(52) U.S. Cl. 434/98; 434/428

(57) ABSTRACT

The invention includes educational methods, processes and kits which result in a memorabilia product having at least one memorabilia page having a complementary designated theme of a defined attraction, and at least one educational component complementary to the designated theme of the defined attraction.

### CROSS-REFERENCE TO RELATED APPLICATIONS

The present application claims the benefit of U.S. Provisional Patent Application No. 61/286,494, filed Dec. 15, 2009, which is incorporated herein by reference in its entirety as if fully set forth herein.

### BACKGROUND OF THE INVENTION

The present invention relates to kits, processes, methods and products as educational tools which achieve the production of memorabilia of an event, trip or vacation. Central to the invention is the inclusion of at least one memorabilia page having a designated theme character of a defined attraction, and at least one educational component complementary to the designated theme character of the defined attraction of the at least one memorabilia page.

Family vacation trips to theme parks are a well recognized part of society and can be the central family bonding activity during the year. Usually these trips occur during periods when schools are on vacation (e.g. summer break, winter break and spring break), wherein children focus away from educational lessons. Trips to designated theme parks are usually planned wherein a percentage of the financial and time budget is devoted to memorabilia or souvenirs. Most memorabilia items are usually standard printed cups, t-shirts, posters etc., which have little or no input from the participants of the vacation and have little or no educational component. Further, these items usually are obtained by a single purchase which does not enhance participation in the vacation.

Recently there has been a growing activity wherein theme parks which include characters (e.g. Disney, Warner Bros. and Six Flags) allow interaction of the characters with the vacation participants so as to obtain “autographs” of the designated theme park character as a “keepsake” of the vacation. These autographs are usually obtained on a “catch as catch can” basis within the theme park and on a generic autograph book which is basically little more than blank pages.

There is a need for the ability to enhance the vacation experience by increased participation in obtaining personalized memorabilia while including an educational component.

### BRIEF SUMMARY OF THE INVENTION

In a first embodiment, the invention is directed to a memorabilia and educational kit which includes a plurality of memorabilia pages each having a designated theme character of a defined attraction, with at least one map having directional compass markings of the defined attraction complementary to the plurality of memorabilia pages. Further, the kit includes a color recognition table coordinated with the designated theme character of the plurality of memorabilia pages and a compass complementary to the directional compass markings on the plurality of memorabilia pages having a designated theme character.

In another embodiment, the invention is directed to a method for educational color recognition, map comprehension and reading text while making a memorabilia book. The method includes creating a plurality of pages having a designated theme character of a defined attraction, obtaining a map of the defined attraction, creating a color recognition table coordinated with the map complementary to the designated theme of the plurality of pages, and creating a reading component complementary to the plurality of pages. The plurality of pages, the map, the color recognition table and the reading component, are then bound in a reversible manner. Thereafter, the method continues by locating, recognizing and reading the at least one designated theme character on the plurality of pages; recognition memorabilia is obtained for the designated theme character. All of the previous steps are repeated for each designated theme character desired. The recognition memorabilia is then bound in a permanent manner.

In yet another embodiment, the invention is directed to a memorabilia product created by a defined process. The process includes creating a plurality of pages having a designated theme character, creating a map of a defined attraction, creating a color recognition table coordinated with the designated theme of the plurality of pages, and creating a reading component complementary to the plurality of pages. The plurality of pages, the map, the color recognition table and the reading component are then bound in a reversible manner. Thereafter, the process continues by locating, recognizing and reading the at least one designated theme character on the plurality of pages. Thereafter, recognition memorabilia is obtained for the at least one designated theme character. All of the previous steps are repeated for each designated theme character desired. The recognition memorabilia is then bound in a permanent manner to complete the process and form the memorabilia product.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE SEVERAL VIEWS OF THE DRAWINGS

The invention will be described with reference to the following drawings, it being understood that the invention is not limited to the precise images or configurations as shown:

FIG. 1 is a top view of the invention in an assembled form;

FIG. 1A is a top view of the invention of FIG. 1 illustrating the rotation of the components of the invention;

FIG. 2 illustrates a permanent binder of the invention of FIGS. 1 and 1A; and

FIG. 3 is a flow chart of a method of the invention.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

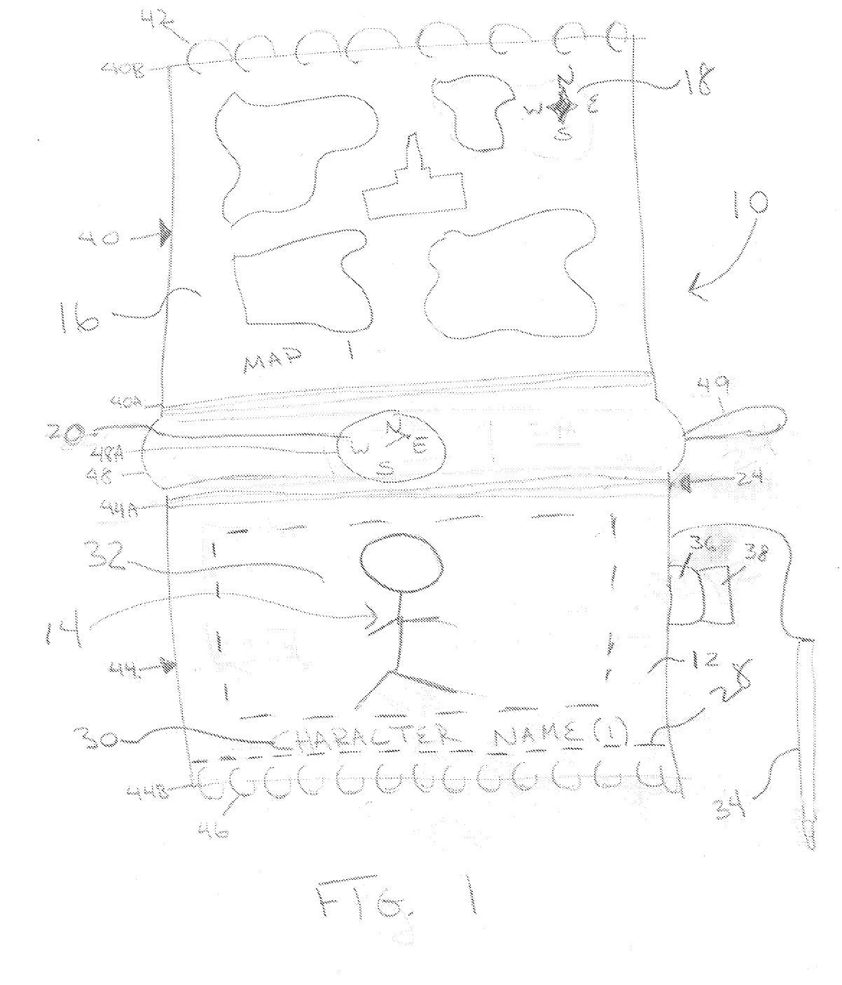

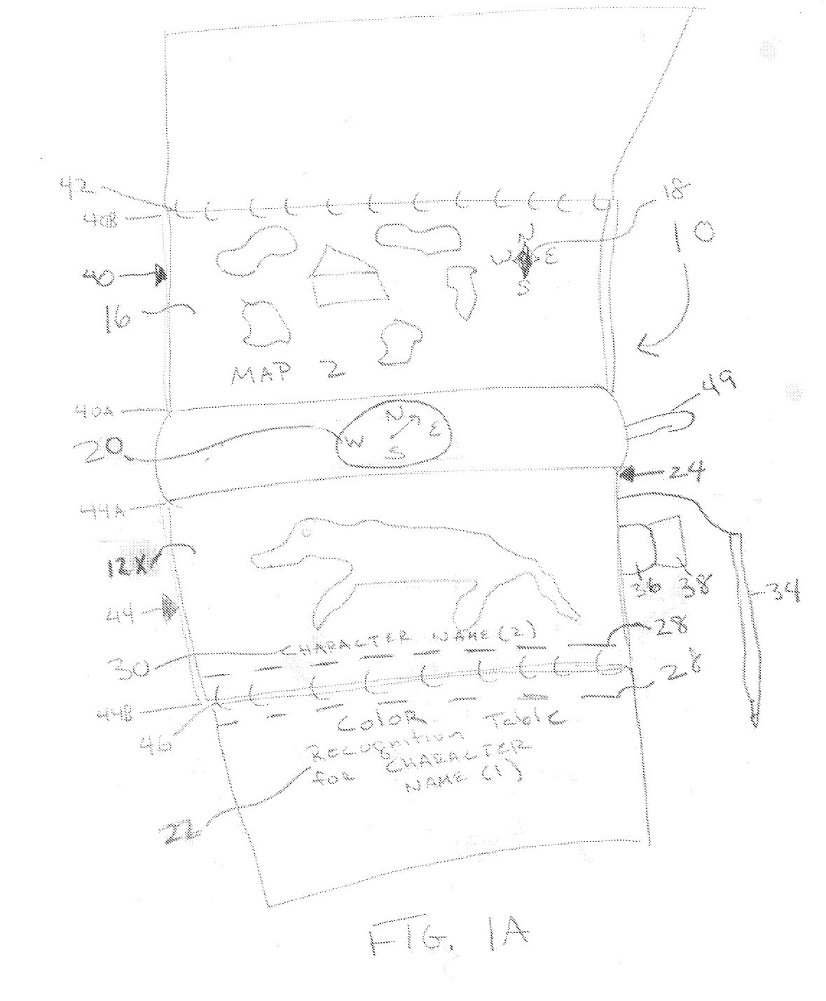

Referring to FIGS. 1 and 1A, in a first embodiment, the invention is directed to a memorabilia and educational kit 10, illustrated in an assembled arrangement. In general, the memorabilia and educational kit 10 includes at least one memorabilia page having a designated theme character 14 of a defined attraction, and at least one educational component complementary to the designated theme character of the at least one memorabilia page.

It is understood that the invention could be provided wherein each of the at least one memorabilia pages are separated for personalizing by the user. For example, dates, names, photographs and other information could be included by the user prior to assembly.

In this embodiment, the at least one memorabilia page 12 is a plurality of memorabilia pages 12X each having a complementary designated theme character 14. It is appreciated that two characters (or more) may be on the same memorabilia page 12. At least one map 16 of a defined attraction complementary to the plurality of memorabilia pages 12X is included having directional compass markings 18. The map 16 allows the user to locate the designated theme character 14 within the attraction (or “theme park”) to obtain autographs (of the designated theme character 14) to produce a memorabilia product and learn (or strengthen) various educational skills as discussed herein. A compass 20 complementary to the directional compass markings 18 on the map 16 is included so as to support map learning while obtaining the memorabilia.

Referring to FIG. 1A, the kit 10 includes a color recognition table 22 coordinated with the map 16 complementary to the designated theme character(s) 14 of the plurality of pages 12X. As illustrated in FIG. 1A, the table 22 can be located on the reverse side of the memorabilia page 12, but one skilled in the art would recognize that the location of the table 22 could be in a variety of positions so long as access is available. Specifically, the at least one map 16, compass markings 18, compass 20 and color recognition table 22 act in tandem as educational tools to allow the user to locate (via the at least one map 16, compass markings 18 and compass 20) and identify (via the color recognition table 22) the designated theme character 14 they have selected to produce a “personalized” memorabilia product.

The kit 10 could include a list (not shown) to direct the user to the correct schedule and location of the designated theme character to obtain the memorabilia. Further, this list could be obtained in an updated form at the resort as it is common for theme parks to circulate the location and schedule for designated theme character 14 on a routine basis.

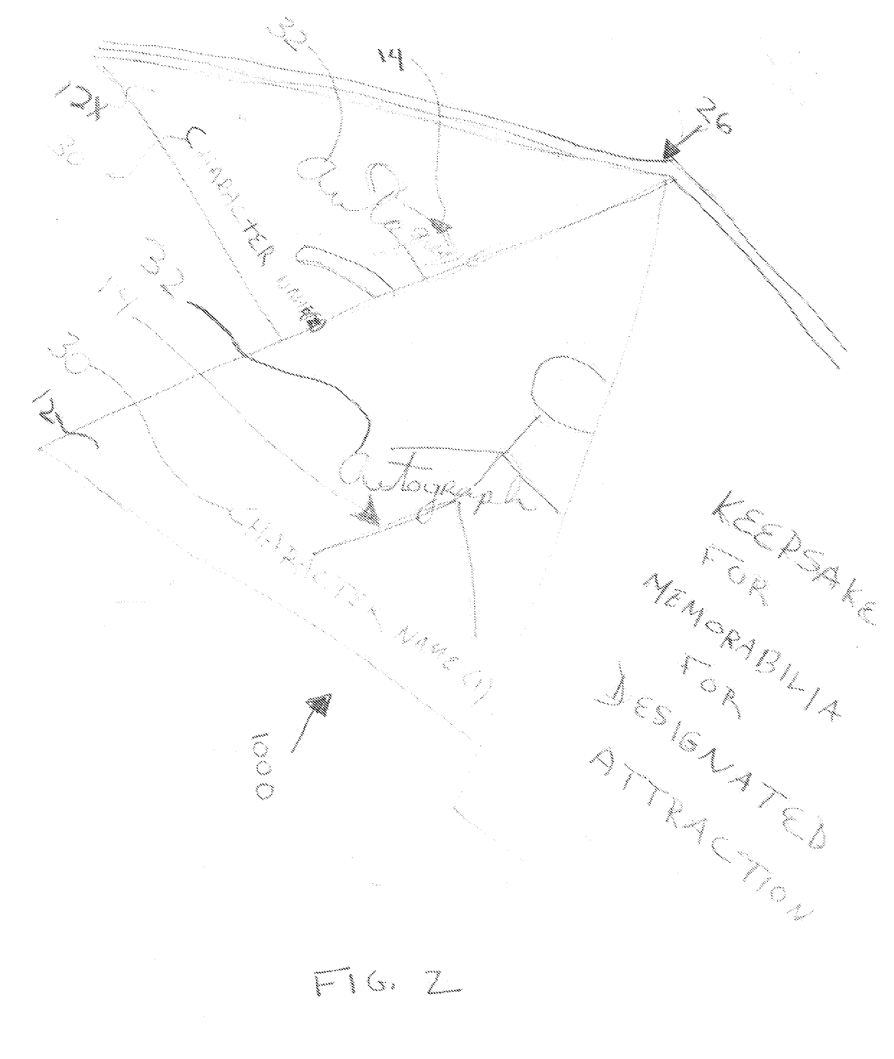

As illustrated in FIGS. 1 and 1A, the kit 10 is assembled in a temporary binder 24 which will be used while the memorabilia is being acquired within the educational exercises of mapping, reading and color coordination, as discussed herein. Most commonly, the memorabilia is in the form of an autograph of the designated theme character 14 on the plurality of memorabilia pages 12X (as best illustrated in FIG. 2). Upon assembly, the plurality of pages 12X, the map 16, the color recognition table 22 and the compass 20 are reversibly bound in the temporary binder 24 allowing personalizing as discussed herein.

The kit 10 further includes a permanent memorabilia binder 26 as illustrated in FIG. 2, which can be a permanent “keepsake” of the event, trip or vacation. One of skill in the art would recognize the permanent memorabilia binder 26 could be of various configurations (e.g. wire binding, clamp binding, adhesive binding etc). Key to the permanent binder 26 is that it will bind the plurality of memorabilia pages 12X to form the memorabilia product 1000. It is appreciated that additional memorabilia pages 12X may be added if supplemental kits are required (as discussed herein). As illustrated in FIG. 2, each of the plurality of memorabilia pages 12X have been “autographed”. As illustrated in FIGS. 1 and 1A, each of the plurality of memorabilia pages 12X can include a perforated portion 28 to allow a more space efficient article of memorabilia when being attached to the permanent binder 26.

In this embodiment, and most common to the invention, the plurality of memorabilia pages 12X includes a reading component 30. The reading component 30 can be the name of a designated theme character 14 found at the attraction for which memorabilia, in the form of an autograph, is desired. Therefore, the reading component 30 complementary to the designated theme park character(s) 14 continues as an educational component after the memorabilia is obtained and the trip is completed. Specifically, the written name of the designated theme character 14 acts as the reading component 30 in conjunction with the at least one memorabilia page 12, usually including an “image” of the designated theme character 14. This allows reinforcement of reading skills including learning sounds of letters and combinations of letters. It is understood that the map 16 could also include one or more reading components wherein names of large buildings and/or landmarks could be written on the map 16.

An “autograph” will be placed by the designated theme character 14 on the at least one memorabilia page 12 in an autograph component 32 which usually forms a boundary of the designated theme character 14, as best illustrated in FIG. 2, to form the memorabilia product 1000.

Recognizing that various surfaces may be used on the plurality of pages 12X so as to appreciate the activity and contact with various substances such as rain, food stuff and related materials which come into contact with the assembled kit 10, the kit 10 further includes a writing utensil 34 complementary to the autograph component 32. The writing utensil 34 is most commonly tethered to the binder 24, having a storage device 36 so not be lost or misplaced while the user is in the attraction. One of skill in the art would recognize that a variety of surfaces could be used on the plurality of pages 12X with the complementary writing utensil 34.

In addition, the storage position device 36 could include a fastener component 38 to close the temporary binder 24 while not in use and/or being carried by the user. Various forms of the storage position device 36 and the fastener component 38 could be used without deviating from the concept of including the two functions of 1) fastening the temporary binder 24 in a closed position and 2) securing the writing utensil 34.

Referring again to FIGS. 1 and 1A, the kit 10 is illustrated assembled in a temporary binder 24 which has a first section 40 having a first end 40A and second end 40B, wherein the second end 40B has a releasable binding device 42, the releasable binding device 42 allowing rotation of the at least one map 16. A second section 44 has a first end 44A and second end 44B, wherein the second end 44B has a releasable binding device 46, the releasable binding device 46 allowing rotation of the plurality of memorabilia pages 12X. A hinge section 48 is positioned between the first section 40 and the second section 44, wherein the hinge section 48 has a compass section 48A to hold the compass 20. As noted herein, upon obtaining the memorabilia, (e.g. the autographed plurality of memorabilia pages 12X), each “memorabilia page” can be transferred to the permanent binder 26, forming the memorabilia product (e.g. book) as best illustrated in FIG. 2, and the remainder of the kit 10 can be discarded.

The hinge section 48 of the temporary binder 24 includes an extending attachment device 49, such as a clasp or hook to allow attachment to (e.g. the clothing of) the user. Specifically, the extending attachment device 49 could be a hook which opens/closes to temporarily attach to (e.g., a belt hook on a pair of shorts) thereby allowing the temporary binder 24 to be easily carried while enjoying a theme park.

As it is recognized that a portion of the kit 10 would be discarded upon obtaining the autographed plurality of memorabilia pages 12X and placing them into the permanent binder 26, the temporary binder 24 should be made of a biodegradable material to help preserve the environment, thereby recognizing this embodiment as a “green technology”.

Recognizing that new characters are continuously introduced via feature films etc., “supplement kits” (not shown) could be created and sold separately based on the new characters. These supplement kits would include at least one memorabilia page having a complementary designated theme character, wherein the designated theme character is based on the new characters and the at least one memorabilia page is functional with the temporary binder 24, illustrated in FIGS. 1 and 1A, and the permanent memorabilia binder 26 illustrated in FIG. 2.

The various parts of the invention are to be provided both as a kit of several cooperating pieces and as a supplement kit. An important objective of the invention is to provide a basic kit for starting on a small scale to obtain memorabilia for a particular event (e.g. vacation) and permitting expansion later with additional memorabilia obtained during subsequent vacations and trips to the same or related destinations (e.g. theme parks).

Additional embodiments will now be described wherein like features are denoted by like reference numbers.

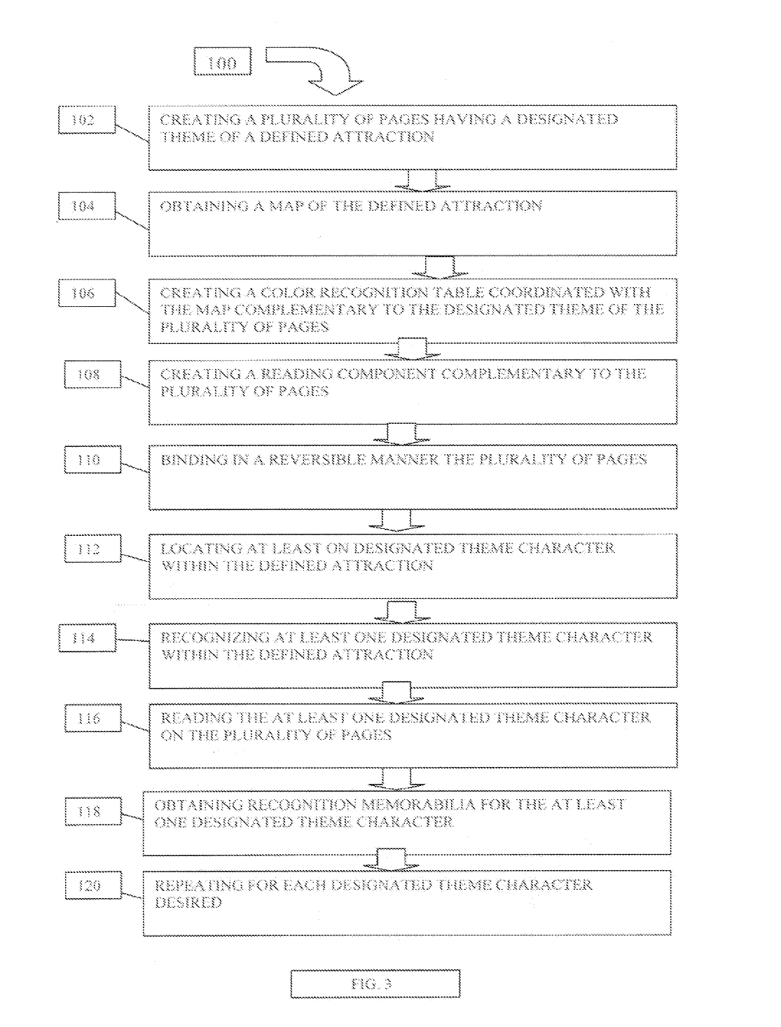

Referring to FIG. 3, in yet another embodiment, the invention is directed to an educational method 100 including color recognition, map comprehension and reading text, while making a memorabilia book/product. Referring to FIG. 3, a flowchart illustrates the method 100 is initiated by creating a plurality of pages having a designated theme of a defined attraction 102. The plurality of pages can be accumulated by the user, by creating each individual page as they desire, obtaining the plurality of pages from a commercial source, or a combination of the both. The pages will be created based on the interest and preference of the user arranged by order of importance to the user, or based on other factors as discussed herein.

Thereafter, the method continues by obtaining a map of the defined attraction 104, creating a color recognition table coordinated with the map complementary to the designated theme character of the plurality of pages 106, and creating a reading component complementary to the plurality of pages 108, to locate and recognize the desired characters of the attraction to create the memorabilia. As with the plurality of pages, the map, reading component and color recognition chart, can be created by the user, obtained from a commercial source, or combination of both. Thereafter, the method continues by binding, in a reversible manner, the memorabilia pages, map, color recognition table and reading component 110, for easy transport to, and carrying while at the attraction.

Once at the attraction, the method continues by locating and recognizing at least one designated theme character within the defined attraction 112. Thereafter, upon recognizing the at least one designated theme character 114, and reading the at least one designated theme character on the plurality of pages 116, recognition memorabilia is obtained for the at least one designated theme character 118 (most commonly in the form of an autograph of the memorabilia page with the designated theme character). The above method is repeated for each designated theme character desired 120, as defined by the creation of the plurality of pages, as discussed above.

At the completion of obtaining the memorabilia, binding the plurality of pages most commonly, bound in a permanent manner, completes the educational method allowing learning during a vacation or other family outing.

One of skill in the art would recognize that various features which are commonly available could be included as desired by the user without deviating from the central concept of the invention. For example, it is recognized that obtaining the map could include global positioning system “GPS” technology or could the plurality of pages could include a voice recording device. The addition or deletion of these types of commercially available technologies would be based on the desire of the user, cost issues and the ability of these technologies to complement each other in a completed system.

In yet another embodiment, the invention is directed to a memorabilia product produced by a process. Similar to the method, the process is initiated by creating a plurality of pages having a designated theme character of a defined attraction. The plurality of pages can be accumulated by the user, by creating each individual page as they desire, obtaining the plurality of pages from a commercial source, or a combination of the both. The pages will be created based on the interest and preference of the user arranged by order of importance to the user, or based on other factors as discussed herein.

Thereafter, the process continues by obtaining a map of the defined attraction, creating a color recognition table coordinated with the map complementary to the designated theme character of the plurality of pages, and creating a reading component complementary to the plurality of pages, to locate and recognize the desired characters of the attraction to create the memorabilia product. As with the plurality of pages, the map, reading component and color recognition chart, can be created by the user, obtained from a commercial source, or combination of both. Thereafter, the process continues by binding, in a reversible manner, the memorabilia pages, map, color recognition table and reading component, for easy transport to, and carrying while at the attraction.

Once at the attraction, the process continues by locating and recognizing at least one designated theme character within the defined attraction. Thereafter, upon recognizing the at least one designated theme character, and reading the at least one designated theme character on the plurality of pages, recognition memorabilia is obtained for the at least one designated theme character; most commonly in the form of an autograph of the memorabilia page with the designated theme character. The above process is repeated for each designated theme character desired, as defined by the creation of the plurality of pages, as discussed above. This process creates a memorabilia product which is personalized.

The process may further include creating a plurality of pages having at least one supplement designated theme character and repeating the process for each supplement designated theme character to obtain the memorabilia in a like manner to the designated theme character as discussed herein. Thereafter, the memorabilia, in the form of an autographed supplemental designated theme character, is bound in the permanent binder with the autographed designated theme character.

### Example 1

As many vacation families with young children are familiar with the Disney theme parks and characters, it will be appreciated how the present invention is directed to this type of venue. Specifically, referring to FIGS. 1 and 1A, the designated theme character 14 could be “Snow White”; a recognizable character for children at a very young age. Based on this recognition, the present invention would be used as an educational tool as well as creating a memorabilia product 1000 as illustrated in FIG. 2.

As described herein, the present invention could be sold as a kit 10 wherein the user would assemble the kit 10 in order to obtain a personalized memorabilia product. It would be recognized that the designated theme character 14 of a specified theme park (e.g. Disney in this example), could be directed to: a) Disney characters most commonly acquired by boys, (e.g. Mickey Mouse, Donald Duck, Buzz Light Year); b) Disney characters most commonly acquired by girls (e.g. Cinderella, Snow White, Arial); or c) a combination of all characters, placed within the temporary binder 24, as illustrated in FIGS. 1 and 1A, to obtain a personalized memorabilia product 1000, as best illustrated in FIG. 2 in the permanent binder 26.

The inclusion of the maps 16, color recognition table 22 and reading component 30 allow the opportunity to learn while obtaining the memorabilia; illustrated as the autographed plurality of memorabilia pages 12X in FIG. 2. As discussed herein, after the user assembles the components of the kit 10 in a “personalized” manner, usually prior to arriving at a Disney theme park, the educational portion begins by using the maps of the Disney parks (included in a kit of the present invention directed to a Disney theme park) to find the characters using the compass 20 at defined locations on the map 16, such as Cinderella's Castle.

The color recognition table 22, complementary to each designated theme character 14, allows specific comparison of color to character (e.g. Snow White's dress has a yellow skirt with a blue blouse). These basic recognition color comparisons will allow the user to associate the character with colors and thereafter, associate the characters with the reading component (e.g. the name of the character, Snow White).

This same procedure can be performed for all designated theme characters 14 desired in the assembled temporary binder 24 based on the personalized selection from the kit as discussed herein. Thus, by using decision skills (e.g. selecting the characters the user wants to acquire), hand coordination skills (e.g. assembling the components in the temporary binder 24), map skills, color recognition skills and reading skills, the user is a central participant in acquiring the memorabilia product which thereby increases the aesthetic and sentimental worth of the completed memorabilia product.

The user thereafter transfers the memorabilia, an autographed memorabilia page of Snow White in this example, to the permanent memorabilia binder 26 by detaching at the perforated section 28 of the (Snow White) memorabilia page 12 and the temporary binder 24. Additionally, each piece of memorabilia can be inserted into a biodegradable plastic envelope (not shown) to increase durability over the years of review. The plastic envelopes can be included with the kit to ensure the “perforated” plurality of memorabilia pages are a complementary fit and the “binding” device into the permanent binder 26 is functionally complementary.

As discussed, supplement kits could be obtained which would include new “Disney” characters as designated theme characters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claim.

We claim:

1. A memorabilia and educational kit comprising:
a. at least one memorabilia page having a complementary designated theme character of a defined attraction; and
b. at least one educational component complementary to the designated theme character of the at least one memorabilia page.

2. The kit of claim 1, wherein the at least one educational component is a plurality of educational components comprising:
a. at least one map having directional compass markings of the defined attraction;
b. a compass complementary to the directional compass markings on the at least one map; and
c. a color recognition table coordinated with the at least one map complementary to the designated theme character of the at least one memorabilia page,
wherein the at least one memorabilia page is a plurality of memorabilia pages.

3. The kit of claim 2, wherein memorabilia and educational kit further comprises:
a. temporary binder; and
b. a permanent memorabilia binder.

4. The kit of claim 3, wherein the plurality of memorabilia pages, the map, the color recognition table and the compass are reversibly bound in the temporary binder positioned to be substantially simultaneously accessible to be used in tandem.

5. The kit of claim 4, wherein the plurality of memorabilia pages comprises a reading component.

6. The kit of claim 5, wherein the plurality of memorabilia pages comprise an autograph component.

7. The kit of claim 6, wherein the kit further comprises a writing utensil complementary to the autograph component.

8. The kit of claim 7, wherein the temporary binder comprises:
a. a first section having a first end and second end, wherein the second end has a releasable binding device, the releasable binding device allowing rotation of the at least one map;
b. a second section having a first end and second end, wherein the second end has a releasable binding device, the releasable binding device allowing rotation of the plurality of memorabilia pages; and
c. a hinge section positioned between the first section and the second section, wherein the hinge section has a compass section to hold the compass.

9. The kit of claim 8, wherein the reading component is the name of the designated theme character on the plurality of memorabilia pages of the defined attraction.

10. The kit of claim 9, further comprising a memorabilia and educational supplement kit comprising:
a, at least one memorabilia page having a complementary designated theme character of a defined attraction; and
b. at least one educational component complementary to the designated theme character of the at least one memorabilia page,
wherein the at least one memorabilia page of the supplement kit is configured to be releasably attachable to the releasable binding device of the second section of the temporary binder allowing rotation, and the at least one educational component of the supplement kit is configured to be releasably attachable to the releasable binding device of the first section of the temporary binder allowing rotation.

11. A method for educational color recognition, map comprehension and reading text while making a memorabilia book comprising the steps of:
a. creating a plurality of pages having a designated theme character of a defined attraction;
b. obtaining a map of the defined attraction;
c. creating a color recognition table coordinated with the map complementary to the designated theme character of the plurality of pages;
d. creating a reading component complementary to the plurality of pages;
e. binding in a reversible manner, a., b., c, and d.;
f. locating at least one designated theme character within the defined attraction;
g. recognizing at least one designated theme character within the defined attraction;
h. reading the at least one designated theme character on the plurality of pages;
i. obtaining recognition memorabilia for the at least one a designated theme character;
j. repeating a-i for each designated theme character desired; and
k. binding in a permanent manner each recognition memorabilia obtained.

12. The method of claim 11, wherein the map includes a GPS system.

13. The method of claim 12, wherein the plurality of pages includes a voice recording device.

14. A memorabilia product prepared by the process of comprising the steps of:
a. creating a plurality of pages having a designated theme character;
b. creating a map of a defined attraction;
c. creating a color recognition table coordinated with the map complementary to the designated theme character of the plurality of pages;
d. creating a reading component complementary to the plurality of pages;
e. binding in a reversible manner a., b., c, and d.;
f. locating at least one designated theme character within the defined attraction;
g. recognizing at least one designated theme character within the defined attraction;
h. reading the at least one designated theme character on the plurality of pages;
i. obtaining recognition memorabilia for the at least one a designated theme character;
j. repeating a-i for each designated theme character desired; and
k. binding in a permanent binder each recognition memorabilia obtained.

15. A memorabilia product prepared by the process of claim 14.
